(19) United States
(12) Patent Application Publication
(10) Pub. No.: US 2024/0197050 A1
(43) Pub. Date: Jun. 20, 2024

(54) FLAT BENDABLE CASE HAVING A SUPPORT MECHANISM

(71) Applicant: Wei-Yin Tsai, Taipei City (TW)

(72) Inventor: Wei-Yin Tsai, Taipei City (TW)

(21) Appl. No.: 18/179,695

(22) Filed: Mar. 7, 2023

(30) Foreign Application Priority Data
Dec. 14, 2022 (TW) 111147970

(51) Int. Cl. A45C 11/00; A45C 13/10; G06F 1/16

(52) U.S. Cl. CPC A45C 11/00; A45C 13/103; A45C 13/1092; G06F 1/1628; A45C 2011/003; A45C 2013/1015; A45C 2200/15

(57) ABSTRACT

A flat bendable case includes a receptacle including a top surface, a bottom surface, and three edges each interconnecting the top surface and the bottom surface so as to form a receiving space and an opening; and a bending mechanism provided in the bottom surface and including a first panel, a second panel connected to the first panel, and at least one pivot joint at a joining portion of the first panel and the second panel. The first panel may pivot with respect to the second panel or vice versa about the at least one pivot joint to form a gable with a folding edge. An object may be placed on a forward inclined portion of the top surface.

### FIELD OF THE INVENTION

The invention relates to flat cases and more particularly to a flat bendable case having a support mechanism

### BACKGROUND OF THE INVENTION

An angle of a screen of a notebook computer can be adjusted in use. However, it is not ergonomic since a keyboard of the notebook computer is disposed horizontally. For ease of use, it is often that a stand is used to support the notebook computer so that the screen of the notebook computer is at an inclined angle with respect to a support surface (e.g., tabletop). However, the conventional stand is not a part of the notebook computer, i.e., being separate. The stand can consume a storage space and is relatively heavy. Further, a briefcase for carrying the notebook computer does not have a space for receiving the stand. Typically, the stand and other items are stored together. Unfortunately, it is messy.

A conventional briefcase for notebook computer is provided with an integral stand. The stand is flat in a storage position. The stand can be taken out and bent to form an inclined structure to support the notebook computer in use. There are two drawbacks of the conventional briefcase. One drawback is that it involves complicated steps of taking out and bending to form the inclined structure. The other drawback is that its inclined angle is preset and limited. Thus, a user cannot adjust the inclined angle based on preference or demand.

Thus, the need for improvement still exists.

### SUMMARY OF THE INVENTION

It is therefore one object of the invention to provide a flat bendable case comprising a receptacle including a top surface, a bottom surface, and three edges each interconnecting the top surface and the bottom surface so as to form a receiving space and an opening; and a bending mechanism provided in the bottom surface and including a first panel, a second panel connected to the first panel, and at least one pivot joint at a joining portion of the first panel and the second panel; wherein the first panel is configured to pivot with respect to the second panel or vice versa about the at least one pivot joint to form a gable with a folding edge; and wherein an object is configured to place on a forward inclined portion of the top surface.

One of the most important objects of the invention is detailed below. After the notebook computer has been placed on the inclined case, an angle of the screen of the notebook computer with respect to the supporting ground (e.g., tabletop) can be adjusted as desired by bending the bending mechanism. A minimum load is borne on the neck of a user when the top of the computer screen and the eyes of the user are at the same elevation according to a search report about computer ergonomics. Fortunately, the support mechanism of the flat bendable case of invention can achieve the above purpose.

The invention has the following advantages and benefits in comparison with the conventional art: the receiving space of the receptacle can be used to receive a multimedia device (e.g., notebook computer or tablet computer). After the multimedia device has been taken out of the receiving space, a user may bend the bending mechanism by pivoting bending mechanism about a pivot joint until the receptacle is shaped as a gable. The multimedia device can placed on the forward portion of the top surface of the receptacle. There is no complicated bending operation involved. The user may adjust an angle of the receptacle (i.e., the multimedia device) with respect to the supporting ground (e.g., tabletop) until a desired angle is obtained.

The above and other objects, features and advantages of the invention will become apparent from the following detailed description taken with the accompanying drawings

### BRIEF DESCRIPTION OF THE DRAWINGS

FIG. 1 is a perspective view of a flat bendable case of a first preferred embodiment of the invention;

FIG. 2 is a side elevation in part section of the flat bendable case in a first configuration prior to being disposed in an inclined angle with respect to a supporting ground;

FIG. 3 is a side elevation in part section of the flat bendable case in a second configuration prior to being disposed in the inclined angle with respect to the supporting ground;

FIG. 4 is a side elevation in part section of the flat bendable case which has been bent to be disposed in the inclined angle with respect to the supporting ground and an open multimedia device is supported by the flat bendable case;

FIG. 5 is a side elevation in part section of a flat bendable case of a second preferred embodiment of the invention in which the flat bendable case has been bent to be disposed in an inclined angle with respect to the supporting ground;

FIG. 6 is a perspective view of a flat bendable case of a third preferred embodiment of the invention; and

FIG. 7 is a perspective view of the flat bendable case of FIG. 6, the flat bendable case being bended.

### DETAILED DESCRIPTION OF THE INVENTION

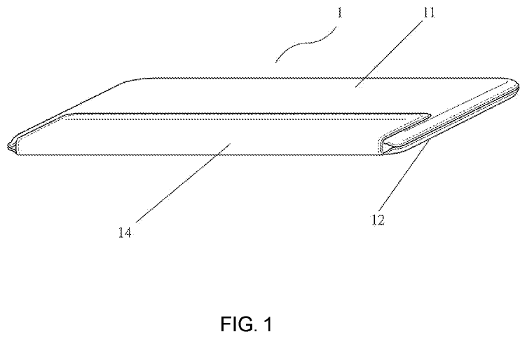

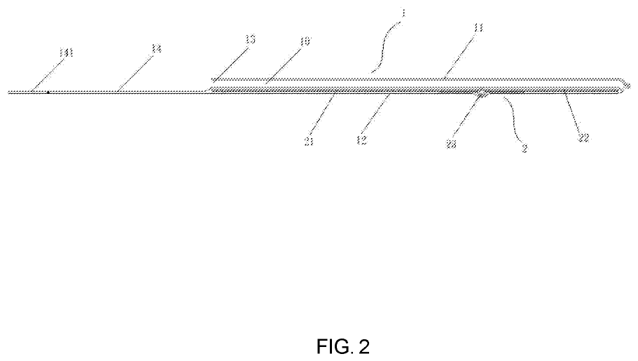

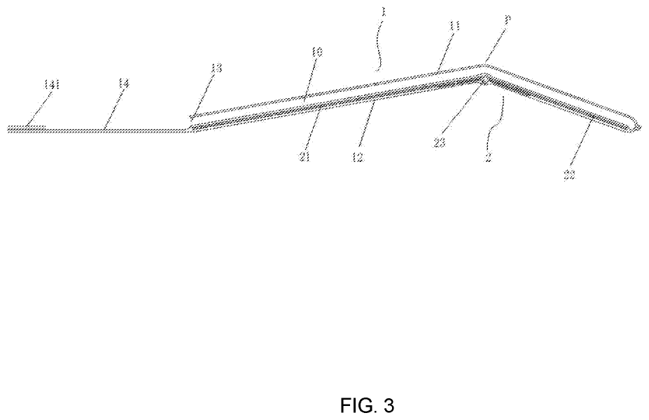

Referring to FIGS. 1 to 4, a flat bendable case in accordance with a first preferred embodiment of the invention comprises the following a receptacle 1 and a bending mechanism 2 as discussed in detail below.

The receptacle 1 includes a top surface 11, a bottom surface 12, and three edges each interconnecting the top surface 11 and the bottom surface 12. The receptacle 1 further comprises a receiving space 10, a flap 14 extending forward from the bottom surface 12, and an opening 13 which is formed when the flap 14 is bent to dispose on the same supporting surface as the bottom surface 12, i.e., the flat bendable case being open. Alternatively, the flap 14 can be bent to rest on the top surface 11 to close the opening 13, i.e., the flat bendable case being closed. The flap 14 includes a folding end 141 which can be folded onto the flap 14 to dispose thereon, i.e., being in a raised position.

Further, a magnetic member (e.g., magnet) provided in the folding end 141 and a metal member is provided in the flap 14 adjacent to the folding end 141. Thus, the folding end 141 (i.e., the magnet) attracts the flap 14 (i.e., the metal member) when the folding end 141 is folded onto the flap 14.

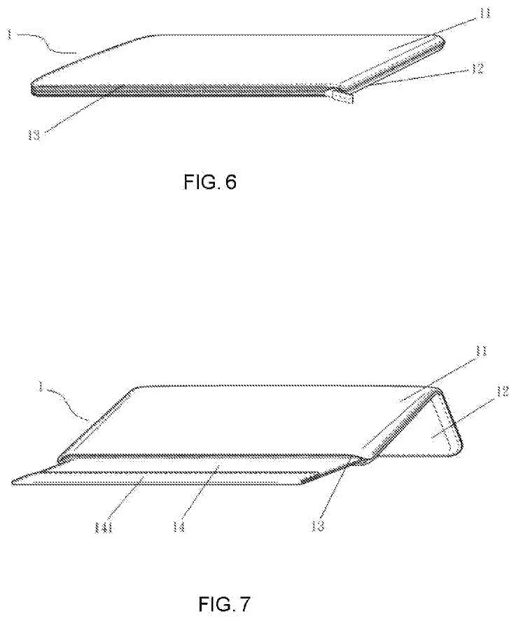

Furthermore, a zipper (as shown in FIG. 6), buckle, or hook and loop fastener is provided on an inner surface of the receptacle 1 proximate the opening 13 so that the opening 13 can be opened or closed by using the zipper, buckle, or hook and loop fastener. In addition, a handle is provided on an outer surface of the opening 13. Both the top surface 11 and the bottom surface 12 are made of soft material (e.g., leather or fabric). The flap 14 can be disposed in the receiving space 10. Finally, the opening 13 is closed by the flap 14 (see FIG. 7).

The bending mechanism 2 is provided in the bottom surface 12. Alternatively, the bending mechanism 2 is provided in the top surface 11. The bending mechanism 2 includes a first panel 21, a second panel 22 connected to the first panel 21, and at least one pivot joint (or a plurality of pivot joints) 23 at a joining portion of the first panel 21 and the second panel 22. The pivot joint 23 is implemented as a torsion pivot joint which allows the first panel 21 to pivot with respect to the second panel 21 or vice versa. In one position, the first panel 21 and the second panel 22 are pivoted to form a gable with a folding edge P.

A pivotal angle of the first panel 21 with respect to the second panel 22 about the pivot joint 23 is between 1 and 90 degrees. Length of the first panel 21 is greater than that of the second panel 22. Both the first panel 21 and the second panel 22 are made of rigid material.

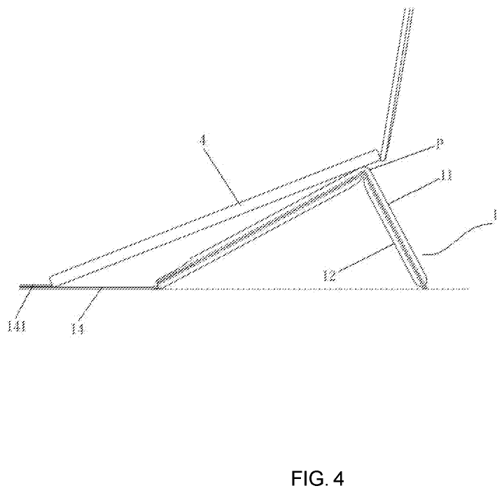

As shown in FIG. 4 specifically, an application of the receptacle 1 of the invention, a multimedia device (e.g., notebook computer, tablet computer, or any electronic device) 4 is stored in the receiving space 10. A user may take the multimedia device 4 out of the receptacle 1 on a tabletop and pivot the second panel 22 with respect to the second panel 22 about the pivot joint 23 until a gable with a folding edge P is formed. Further, the user may fold the folding end 141 onto the flap 14. Next, the user may open the multimedia device 4 and place same on the forward inclined portion of the flat bendable case with a rear portion of a bottom of the multimedia device 4 rested on the folding edge P and a forward end of the bottom of the multimedia device 4 stopped by the raised folding end 141 so that the multimedia device 4 is prevented from sliding downward.

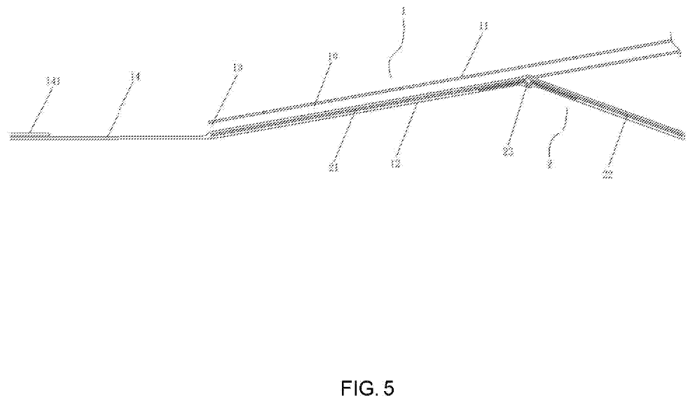

Referring to FIG. 5, a flat bendable case in accordance with a second preferred embodiment of the invention is shown. The characteristics of the second preferred embodiment are substantially the same as that of the first preferred embodiment except the following: a plurality of perforations arranged as a line (i.e., as a pivot joint) are provided through the bottom surface 12 adjacent to the second panel 22. After the first panel 21 has been bent with respect to the second panel 22 about the perforations, the second panel 22 is disposed externally of the receptacle 1. The receptacle 1 shaped as a gable. Thus, a device (e.g., notebook computer, tablet computer, or any electronic device) can be placed on the forward inclined portion of the receptacle 1 and is sufficiently supported.

The invention has the following advantages and benefits in comparison with the conventional art: the bending mechanism 2 is provided in the bottom surface 12 as support. The multimedia device 4 can be placed on the inclined receptacle 1. No complicated bending operation is required to place the multimedia device 4 on the inclined receptacle 1 and the inclined angle can be easily adjusted until an ergonomic angle is obtained. The neck of the user may feel a degree of comfort in use. There is less stress to the eyes. The hidden support is applicable to any shape of the receptacle 1 and makes the receptacle 1 more aesthetic. There is no need to carry a separate stand and store the stand as experienced by the conventional art.

While the invention has been described in terms of preferred embodiments, those skilled in the art will recognize that the invention can be practiced with modifications within the spirit and scope of the appended claims.

What is claimed is:

1. A flat bendable case, comprising:
a receptacle including a top surface, a bottom surface, and three edges each interconnecting the top surface and the bottom surface so as to form a receiving space and an opening; and
a bending mechanism provided in the bottom surface and including a first panel, a second panel connected to the first panel, and at least one pivot joint at a joining portion of the first panel and the second panel;
wherein the first panel is configured to pivot with respect to the second panel or vice versa about the at least one pivot joint to form a gable with a folding edge; and
wherein an object is configured to place on a forward inclined portion of the top surface.

2. The flat bendable case of claim 1, wherein a pivotal angle of the first panel with respect to the second panel about the at least one pivot joint is between 1 and 90 degrees.

3. The flat bendable case of claim 1, wherein the at least one pivot joint is a torsion pivot joint.

4. The flat bendable case of claim 1, further comprising a flap extending forward from the bottom surface adjacent to the opening, the flap being configured to bend to dispose on the top surface to close the opening.

5. The flat bendable case of claim 4, wherein the flap includes a folding end, the folding end being configured to fold onto the flap to form a raised portion.

6. The flat bendable case of claim 5, further comprising a magnetic member in the folding end and a metal member in the flap adjacent to the folding end, the magnetic member being configure to attract the metal member when the folding end is folded onto the flap.

7. The flat bendable case of claim 1, further comprising a plurality of perforations arranged as a line and provided through the bottom surface adjacent to the second panel, wherein after the first panel has been bent with respect to the second panel about the perforations, the second panel is disposed externally of the receptacle.

8. The flat bendable case of claim 1, further comprising a fastening member on an inner surface of the receptacle proximate the opening so that the opening is configured to open or close by using the fastening member.

9. The flat bendable case of claim 8, wherein the fastening member is a zipper, buckle, or hook and loop fastener.
